(19) United States
(12) Patent Application Publication
(10) Pub. No.: US 2026/0003715 A1
(43) Pub. Date: Jan. 1, 2026

(54) INFORMATION PROCESSING METHOD, INFORMATION PROCESSING DEVICE, AND NON-TRANSITORY COMPUTER READABLE RECORDING MEDIUM

(71) Applicant: PANASONIC INTELLECTUAL PROPERTY MANAGEMENT CO., LTD., Osaka (JP)

(72) Inventors: Tadamasa TOMA, Osaka (JP); Seigo ENOMOTO, Kyoto (JP); Yoshihiko MATSUKAWA, Nara (JP); Seikou ABE, Osaka (JP); Mitsuru ENDO, Tokyo (JP)

(73) Assignee: PANASONIC INTELLECTUAL PROPERTY MANAGEMENT CO., LTD., Osaka (JP)

(21) Appl. No.: 19/323,259

(22) Filed: Sep. 9, 2025

Related U.S. Application Data
(63) Continuation of application No. PCT/JP2024/009385, filed on Mar. 11, 2024.
(60) Provisional application No. 63/452,592, filed on Mar. 16, 2023.

(30) Foreign Application Priority Data
Mar. 4, 2024 (JP) 2024-032352

(51) Int. Cl. G06F 11/07

(52) U.S. Cl. CPC G06F 11/0781; G06F 11/0793

(57) ABSTRACT

This information processing device is configured to: acquire input fault data indicating fault content; determine, in order from an upper level, a corresponding focus item to which the input fault data corresponds, said item selected from a plurality of focus items which were classified for each of a plurality of levels and which are for narrowing down the countermeasures to or the causes of the fault content; and display, on a display device, the corresponding focus item determined for each of the plurality of levels.

### FIELD OF INVENTION

The present disclosure relates to a technique for presenting a fault.

### BACKGROUND ART

Patent Literature 1 discloses a knowledge model construction system that analyzes document data and numerical data included in case data to generate a plurality of factors, a relationship between the plurality of factors, information on a mutual relationship between the plurality of factors, and a contribution between the plurality of factors, and stores the generated information in a knowledge model.

However, since the above-described conventional technique merely discloses the construction of a knowledge model, there is a problem that the user cannot learn know-how for handling faults.

Patent Literature 1: Japanese Patent No. 6909596

### SUMMARY OF THE INVENTION

The present disclosure has been made to solve such a problem, and an object of the present disclosure is to provide a technique that allows a user to learn know-how on handling faults.

An information processing method according to one aspect of the present disclosure is an information processing method in a computer, including: acquiring input fault data indicating fault contents; determining a relevant focus item corresponding to the input fault data in order from an upper level from among a plurality of focus items classified for each of a plurality of levels for narrowing down countermeasures to or causes of the fault content; and displaying the relevant focus item determined for each of the plurality of levels on a display device.

According to the present disclosure, a user can learn know-how of handling faults.

### BRIEF DESCRIPTION OF THE DRAWINGS

FIG. 1 is a diagram illustrating one example of an overall configuration of an information processing system in an embodiment.

FIG. 2 is a diagram illustrating a specific example of processing of extracting a candidate group from input fault data.

FIG. 3 is a diagram illustrating an example of processing of specifying an associated part from instruction manual information.

FIG. 4 is a flowchart illustrating an example of processing when the information processing system determines a relevant focus item.

FIG. 5 is a flowchart illustrating an example of processing in which the information processing system creates a database.

FIG. 6 is a diagram illustrating an example of a data configuration of a format.

FIG. 7 is a diagram schematically illustrating conversation data.

FIG. 8 is a diagram illustrating a display example of FTA.

### DETAILED DESCRIPTION

### Knowledge Underlying Present Disclosure

An assistance system that assists a site worker (user) in handling a fault in a case where the fault occurs in a factory facility, a production process, or the like has been studied. In this assistance system, case data including a fault content that has occurred in the past and causes or countermeasures corresponding to the fault content is stored in a database, a cause or countermeasure candidate corresponding to the fault content input by the user is searched from the database, and the searched cause or countermeasure candidate is presented to the user.

In the assistance system under consideration, the causal relationship between the fault content and the presented cause or countermeasure candidate has not been indicated. Therefore, in the assistance system that has been studied, there is a problem that the user cannot determine validity of the presented cause or countermeasure candidate, and the user cannot learn know-how such as what to check and in what order with respect to the fault content to narrow down the causes or countermeasures. With this configuration, it is not possible to improve the user's ability to handle an unknown fault.

Therefore, the present inventors have found that such a problem can be solved by determining, in order from the upper level, a focus item corresponding to fault data input by the user from among a plurality of focus items related to a fault content classified into a plurality of levels for narrowing down the countermeasures to and the causes of the fault content, and presenting the focus item determined for each level to the user, and have arrived at the present disclosure.
(1) An information processing method of the present disclosure is an information processing method in a computer, including: acquiring input fault data indicating fault contents; determining a relevant focus item corresponding to the input fault data in order from an upper level from among a plurality of focus items classified for each of a plurality of levels for narrowing down countermeasures to or causes of the fault content; and displaying the relevant focus item determined for each of the plurality of levels on a display device.

According to this configuration, the relevant focus item corresponding to the input fault data input by the user is sequentially determined from the upper level, and the relevant focus item determined for each level is presented to the user. Therefore, it is possible to present the user with a focus item for narrowing down the countermeasures to or the causes of the input fault data. Therefore, the user can learn know-how such as what to check and in what order with respect to the fault content indicated by the input fault data to narrow down the causes or countermeasures.
(2) In the information processing method according to (1), the determining of the relevant focus item in each level lower than the first level may include determining the relevant focus item by matching a word included in fault data with a keyword indicating a plurality of predetermined focus items.

According to this configuration, since the user can determine the relevant focus item by selecting the focus item corresponding to the input fault data from the candidate group prepared for each of the plurality of levels, the user can easily select the focus item. Furthermore, since the relevant focus item is determined by the selection of the user, the intention of the user can be reflected in the relevant focus item.
(3) In the information processing method according to (1) or (2), the determining of the relevant focus item in a first level that is an uppermost level may include determining the relevant focus item by inputting the input fault data to a learning model that has learned a relationship between fault data and the relevant focus item corresponding to the fault data.

According to this configuration, the relevant focus item in the first level can be automatically determined using the learning model.
(4) In the information processing method according to (3), the determining of the relevant focus item in each level lower than the first level may include determining the relevant focus item by matching a word included in fault data with a keyword indicating a plurality of predetermined focus items.

According to this configuration, the relevant focus item in each level lower than the first level can be automatically determined.
(5) The information processing method according to any one of (1) to (4) may further include: extracting, based on the relevant focus item, a candidate group including a plurality of pieces of countermeasure-and-cause information that are candidates for the countermeasures to or the causes of the fault content indicated by the input fault data from a database that stores the countermeasure-and-cause information indicating the countermeasures or the causes hierarchically classified according to the plurality of focus items, and displaying the extracted candidate group on the display device.

According to this configuration, since the plurality of pieces of countermeasure-and-cause information as candidates for the countermeasures to or causes of the fault content indicated by the input fault data are displayed on the display device, the user can easily narrow down the countermeasures to and the causes of the fault content.
(6) The information processing method according to (5) may further include: determining one piece of countermeasure-and-cause information from the candidate group based on a selection instruction of a user; specifying an associated part of the instruction manual related to the one piece of countermeasure-and-cause information based on instruction manual information indicating an instruction manual of a facility; and displaying the associated part on the display device.

According to this configuration, since the associated part of the instruction manual related to the one piece of countermeasure-and-cause information is displayed, the user can quickly handle the fault content indicated by the input fault data.
(7) The information processing method according to (5) or (6) further includes: determining one piece of countermeasure-and-cause information from the candidate group based on a selection instruction of a user; storing, in the database, a number of times of selection made by the user for each of a plurality of pieces of countermeasure-and-cause information from the candidate group; and displaying the plurality of pieces of countermeasure-and-cause information included in the candidate group on the display device in descending order of the number of times of selection.

According to this configuration, it is easy to narrow down one piece of countermeasure-and-cause information.
(8) In the information processing method according to (4), the keyword indicating the plurality of focus items may be extracted by clustering past fault data.

According to this configuration, the relevant focus item of the input fault data can be determined according to the past fault data.
(9) An information processing device according to another aspect of the present disclosure is an information processing device including a processor, in which the processor is configured to execute: acquiring input fault data indicating fault contents; determining a relevant focus item corresponding to the input fault data in order from an upper level from among a plurality of focus items classified for each of a plurality of levels for narrowing down countermeasures to or causes of the fault content; and displaying the relevant focus item determined for each of the plurality of levels on a display device.

According to this configuration, it is possible to provide an information processing device in which the user can learn know-how such as what to check and in what order with respect to the fault content indicated by the input fault data to narrow down the causes or countermeasures.
(10) An information processing method according to still another aspect of the present disclosure causes a computer to execute: acquiring input fault data indicating fault contents; determining a relevant focus item corresponding to the input fault data in order from an upper level from among a plurality of focus items classified for each of a plurality of levels for narrowing down countermeasures to and causes of the fault content; and displaying the relevant focus item determined for each of the plurality of levels on a display device.

According to this configuration, it is possible to provide an information processing program in which the user can learn know-how such as what to check and in what order with respect to the fault content indicated by the input fault data to narrow down the causes or countermeasures.

The present disclosure can be also implemented as an information processing system that is operated by such an information processing program. It is needless to say that such a computer program can be distributed via a computer-readable non-transitory recording medium such as a CD-ROM, or via a communication network such as the Internet.

Note that each of the embodiments to be described below shows one specific example of the present disclosure. Numerical values, shapes, constituent elements, steps, order of steps, and the like of the embodiment below are merely examples, and do not intend to limit the present disclosure. A constituent element not described in an independent claim representing a highest concept among constituent elements in the embodiments below is described as an optional constituent element. In all the embodiments, respective contents can be combined.

### Embodiments

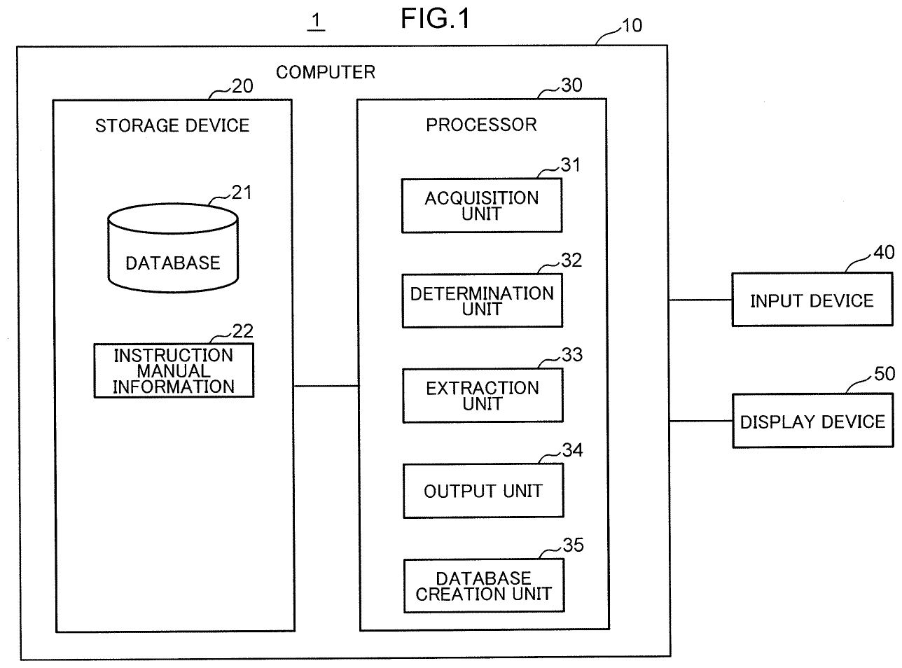

FIG. 1 is a diagram illustrating one example of an overall configuration of an information processing system 1 in an embodiment. An information processing system 1 includes a computer 10, an input device 40, and a display device 50. The computer 10 is an example of an information processing device, and is a device that, when input fault data indicating a fault content occurring in a facility is input, presents a countermeasure to or a cause for the fault content indicated by the input fault data. The facility corresponds to, for example, a production line for producing a product installed in a factory. In the following description, it is assumed that the fault data indicates a fault content occurring in the facility. However, this is an example, and the fault data is not limited to a manufacturing field such as a factory, and may indicate a fault content in a business process in which implicit knowledge of a skilled person is visualized. The implicit knowledge corresponds to, for example, a fault handling procedure, an attention point, and the like.

The computer 10 includes a cloud server, a desktop computer, a portable computer, or the like. The computer 10 includes a storage device 20 and a processor 30. The storage device 20 includes, for example, a nonvolatile rewritable storage device such as a solid state drive (SSD) or a hard disk drive (HDD). The storage device 20 stores a database 21 and instruction manual information 22.

The database 21 stores the countermeasure-and-cause information hierarchically classified according to a plurality of focus items. The countermeasure-and-cause information indicates a countermeasure to or a cause for the fault content indicated by the fault data. The focus item is an item used to narrow down the countermeasures to or the causes of the fault content. In the present embodiment, it is assumed that, in the database 21, the focus items are classified into two levels of a first level and a second level. The first level is the uppermost level, and the second level is one level below the first level.

The focus item in the first level is a focus item that classifies the fault data with the coarsest granularity, and for example, a category of the fault data is adopted. The focus item in the second level is a focus item that classifies the fault content with finer granularity than the first level, and for example, a topic is adopted. The topic is a subject of the fault data. Which topic the fault data belongs to is determined according to the word that appears.

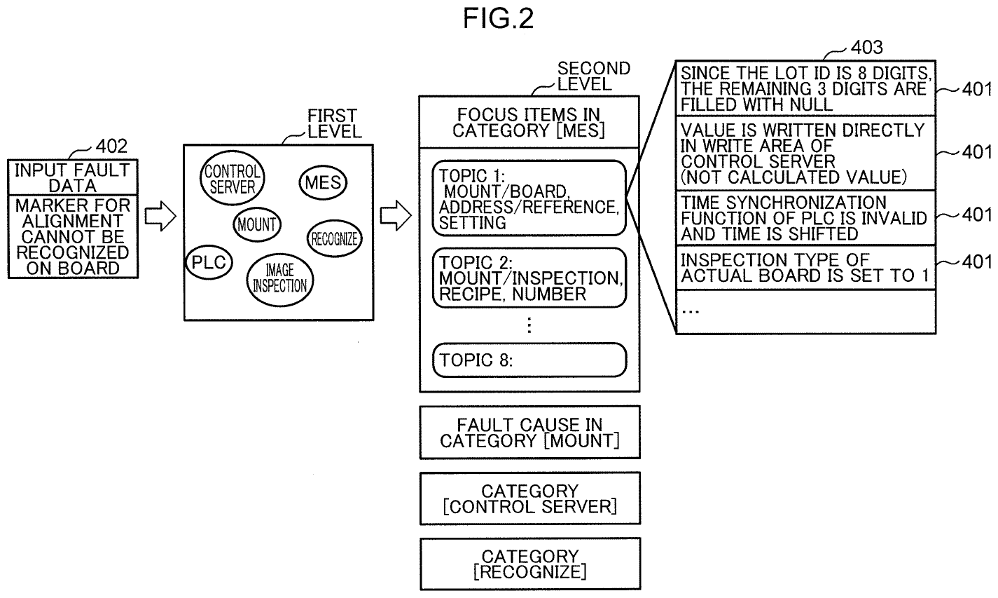

As illustrated in FIG. 2, the database 21 stores a plurality of pieces of countermeasure-and-cause information 401. Each piece of the countermeasure-and-cause information 401 is stored in the database 21 such that it is possible to distinguish which focus item the first level belongs to and which focus item the second level belongs to. In the example of FIG. 2, the focus item in the first level includes five categories of “MES”, “control server”, “mount”, “recognize”, “PLC”, and “image inspection”. The second level includes a plurality of topics. For example, the second level of the focus item “MES” in the first level includes eight topics of topics “1” to “8”. Similarly to “MES”, the focus items in the first level other than “MES” are also configured by a plurality of topics.

The four pieces of countermeasure-and-cause information 401 illustrated in FIG. 2 are stored in the database 21 so as to be distinguishable that the focus item in the second level belongs to the topic “1” and the focus item in the first level belongs to “MES”. Here, an example of two levels has been described, but the levels of the database 21 are not limited to two levels, and may be N (N is an integer of 3 or more) levels. Also in this case, each piece of the countermeasure-and-cause information 401 is stored in the database 21 so as to be distinguishable to which focus item in each of the first to N-th levels belongs.

See FIG. 1 again. The instruction manual information 22 indicates an instruction manual of the facility. The instruction manual is an operation manual describing an operation procedure of a facility, an operation procedure for recovering a fault occurring in the facility, a cause of the fault, and the like.

The processor 30 includes a central processing unit (CPU), and includes an acquisition unit 31, a determination unit 32, an extraction unit 33, an output unit 34, and a database creation unit 35. The acquisition unit 31, the determination unit 32, the extraction unit 33, the output unit 34, and the database creation unit 35 are implemented by the CPU executing an information processing program. However, this is an example, and the acquisition unit 31, the determination unit 32, the extraction unit 33, the output unit 34, and the database creation unit 35 may be configured by a dedicated hardware circuit.

The acquisition unit 31 acquires input fault data. The input fault data is fault data whose countermeasure or cause is unknown. The input fault data is input by the user using the input device 40. The fault data used to create the database 21 and the fault data used to learn a learning model to be described later are past fault data. The past fault data includes countermeasure-and-cause information indicating a countermeasure to or a cause for the fault content indicated by the fault data. On the other hand, the input fault data is different from the past fault data in that the input fault data does not include countermeasure-and-cause information.

The determination unit 32 sequentially determines the corresponding focus item, which is the focus item to which the input fault data belongs, from the upper level from among the plurality of focus items. Specifically, for the first level, the determination unit 32 determines the corresponding focus item corresponding to the input fault data by inputting the input fault data to the learning model. This learning model is a learning model in which the relationship between the past fault data and the corresponding focus item (category) corresponding to the past fault data is learned in advance. For example, the learning model is learned such that when past fault data of which the category is “MES” is input, “MES” that is a correct label is output. The MES indicates an operation log of the facility. As the learning model, any learning model may be adopted as long as the learning model solves the classification problem. For example, as the learning model of the first level, various learning models such as a neural network, a deep neural network, a random forest, or a support vector machine can be adopted.

For the second level, the determination unit 32 determines the relevant focus item by matching the word included in the input fault data with the keyword indicating the plurality of focus items.

In the example of FIG. 2, the focus item in the second level related to “MES” includes eight topics, and “mounting/board”, “address/reference”, “setting”, and the like are included as keywords of the topic “1”. Therefore, in a case where the input fault data is classified into “MES”, the determination unit 32 matches the word included in the input fault data with the keyword of each of the eight topics related to “MES”. Then, the determination unit 32 may determine, as the focus item in the second level, a topic including the most words included in the input fault data as the keyword. Alternatively, the determination unit 32 vectorizes the sentence included in the input fault data, and vectorizes the keyword included in the focus item in the second level. Then, the determination unit 32 may determine, from the similarity between both vectors, a focus item including a keyword having the closest vector of the sentence included in the input fault data as the relevant focus item in the second level. As the vector of the sentence and the keyword, for example, word2vector can be employed. As the similarity of the vectors, for example, cosine similarity can be adopted.

The output unit 34 displays the focus item of each level determined by the determination unit 32 on the display device 50.

The extraction unit 33 extracts, from the database 21, a candidate group including a plurality of pieces of countermeasure-and-cause information that are candidates for countermeasures to or causes of the fault content indicated by the input fault data based on the relevant focus item determined by the determination unit 32.

FIG. 2 is a diagram illustrating a specific example of processing of extracting a candidate group 403 from input fault data 402. In the example of FIG. 2, in the input fault data 402, the focus item in the first level is “MES”, and the focus item in the second level is the topic “1”. Therefore, the extraction unit 33 extracts a plurality of pieces of countermeasure-and-cause information 401 belonging to the topic “1” as the candidate group 403.

The output unit 34 displays the plurality of pieces of extracted countermeasure-and-cause information 401 on the display device 50.

The extraction unit 33 determines one piece of countermeasure-and-cause information from the candidate group 403 based on a selection instruction of the user. This selection instruction is input by the user operating the input device 40.

The output unit 34 may store the number of times of selection made by the user from the candidate group for each of the plurality of pieces of countermeasure-and-cause information in the database 21.

The output unit 34 may display the plurality of pieces of countermeasure-and-cause information 401 included in the candidate group 403 on the display device 50 in descending order of the number of times of selection. In addition, the output unit 34 may display a predetermined number of pieces of countermeasure-and-cause information 401 on the display device 50 in descending order of the number of times of selection.

Based on the instruction manual information 22, the output unit 34 may specify an associated part of the instruction manual related to the one piece of countermeasure-and-cause information selected by the user from the candidate group 403, and display the associated part on the display device 50.

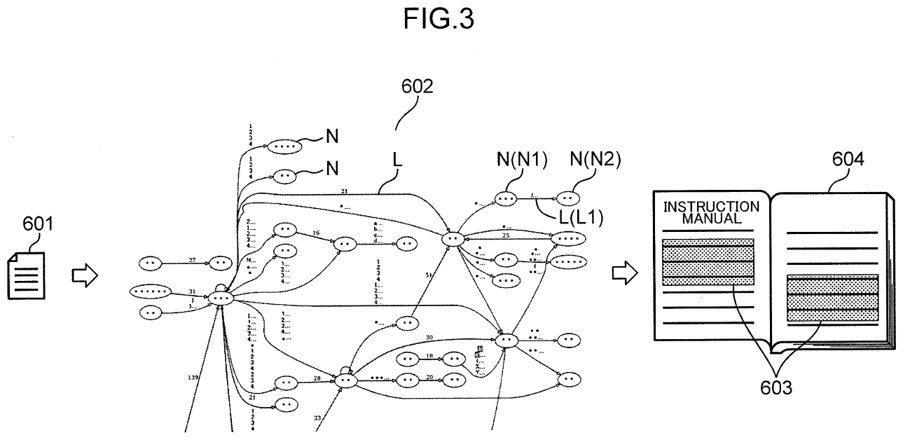

FIG. 3 is a diagram illustrating an example of processing of specifying an associated part from the instruction manual information. Countermeasure-and-cause information 601 is one piece of countermeasure-and-cause information selected by the user from the candidate group 403. Structured data 602 is data obtained by structuring the sentence of each paragraph constituting the instruction manual. The structured data 602 includes a node N representing one word appearing in a paragraph and a link L indicating a relationship between words. For example, since the word indicated by a node N2 appears next to the word indicated by a node N1, the node N1 and the node N2 are connected by a link L1. In addition, the link L1 stores the number of times the word indicated by the node N2 appears next to the word indicated by the node N1.

The output unit 34 generates structured data of a sentence included in the countermeasure-and-cause information 601. Then, the output unit 34 may calculate the similarity between the structured data 602 in each paragraph of the instruction manual and the structured data of the countermeasure-and-cause information 601, and specify one or more paragraphs having the similarity equal to or greater than a threshold as an associated part 603 of the countermeasure-and-cause information 601. Here, the associated part is specified using the structured data 602, but the present disclosure is not limited thereto. For example, the output unit 34 may vectorize the sentence of the countermeasure-and-cause information 601, vectorize each paragraph of the instruction manual, calculate cosine similarity between the vector of the countermeasure-and-cause information 601 and the vector of each paragraph, and specify a paragraph having cosine similarity equal to or higher than a threshold as the associated part. In addition, the output unit 34 may specify the associated part 603 using Jaccard similarity, a Levenshtein distance, Word Embeddings, or the like.

The database creation unit 35 creates the database 21 using the past fault data.

The input device 40 includes an input device such as a keyboard and a mouse, and receives a selection instruction from the user.

The display device 50 includes a display device such as an organic EL display and a liquid crystal display, and displays the candidate group 403, the countermeasure-and-cause information 601, the associated part 603, and the like.

Note that, in a case where the computer 10 includes a cloud server, the input device 40 and the display device 50 may include a terminal device connected to the computer 10 via a network. Examples of the terminal device include a desktop computer, a smartphone, and a tablet computer.

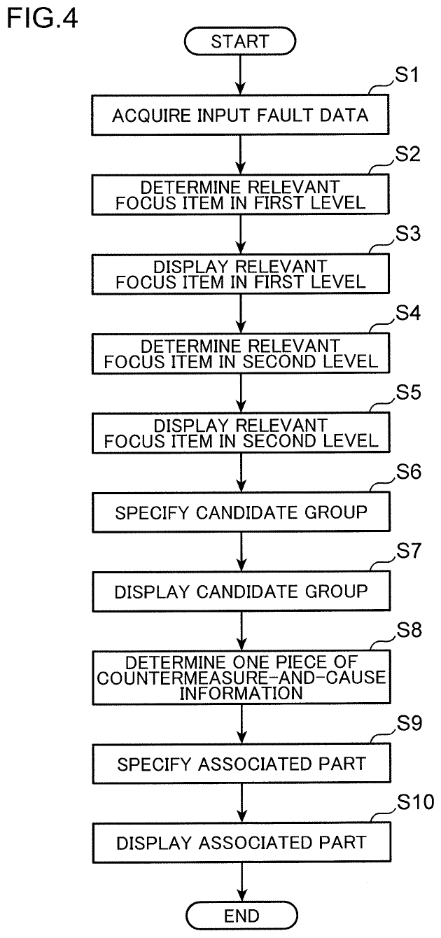

FIG. 4 is a flowchart illustrating an example of processing when the information processing system 1 determines the relevant focus item. First, in step S1, the acquisition unit 31 acquires the input fault data input by the user. Here, for example, as illustrated in FIG. 2, a sentence “a marker for alignment cannot be recognized on a board” is input as the input fault data 402. Note that the user may input the input fault data by voice. In this case, the input device 40 includes a microphone. In this case, the acquisition unit 31 may convert the voice of the input fault data collected by the microphone into text data.

Next, in step S2, the determination unit 32 determines the relevant focus item in the first level by inputting the input fault data to the learning model. Here, as illustrated in FIG. 2, it is assumed that “MES” is determined as the relevant focus item in the first level among the five focus items belonging to the first level.

Next, in step S3, the output unit 34 displays the determined relevant focus item in the first level on the display device 50. Here, “MES” is displayed on the display device 50.

Next, in step S4, the determination unit 32 determines, as the relevant focus item in the second level, the keyword of the topic including the most words included in the input fault data as the keyword. In the example of FIG. 2, among the topics “1” to “8” related to “MES”, the topic including the most words included in the input fault data as the keyword is the topic “1”. Therefore, the determination unit 32 determines the keyword of the topic “1” as the relevant focus item in the second level. Note that, in a case where the relevant focus item other than “MES” is determined in the first level, the determination unit 32 may determine the keyword of the topic including the most words included in the input fault data among the plurality of topics related to the relevant focus item as the relevant focus item in the second level.

Next, in step S5, the output unit 34 displays the determined relevant focus item in the second level on the display device 50. Here, the keyword indicating the topic “1” is displayed on the display device 50. Note that the output unit 34 may generate a sentence of the topic “1” by converting the keyword indicating the topic “1” into a sentence and display the generated sentence of the topic “1” on the display device 50. For example, the output unit 34 may generate the sentence of the topic “1” by inputting the keyword indicating the topic “1” to the natural language processing model such as the bidirectional encoder representations from transformers (BERT) and display the generated sentence of the topic “1” on the display device 50.

Next, in step S6, the extraction unit 33 extracts a plurality of pieces of countermeasure-and-cause information 401 associated with the relevant focus item in the second level determined in step S4 from the database 21, and specifies a predetermined number of pieces of countermeasure-and-cause information 401 as the candidate group 403 in descending order of the number of times of selection by the user among the extracted countermeasure-and-cause information 401.

Next, in step S7, the output unit 34 displays the specified candidate group 403 on the display device 50. In this case, the output unit 34 displays the plurality of pieces of countermeasure-and-cause information 401 included in the candidate group 403 on the display device 50 in descending order of the number of times of selection. Here, as illustrated in FIG. 2, four pieces of countermeasure-and-cause information 401 included in the candidate group 403 are displayed on the display device 50. In addition, the number of times of selection of the countermeasure-and-cause information 401 illustrated in FIG. 2 is larger as it is displayed on the upper side. Therefore, the countermeasure-and-cause information 401 included in the candidate group 403 is displayed on the display device 50 in this order.

Next, in step S8, the output unit 34 determines one piece of countermeasure-and-cause information (countermeasure-and-cause information 601) from among the plurality of pieces of countermeasure-and-cause information 401 displayed as the candidate group 403 on the display device 50 based on a selection instruction from the user. For example, the user may determine the countermeasure-and-cause information 601 by inputting an operation (for example, a tap or click) to designate a display field of the desired countermeasure-and-cause information 401 from among the plurality of pieces of countermeasure-and-cause information 401 displayed as the candidate group 403 on the display device 50.

Next, in step S9, the extraction unit 33 calculates a similarity between the structured data of the countermeasure-and-cause information 601 and the structured data for each of a plurality of paragraphs in the instruction manual, and specifies a paragraph for which the calculated similarity is equal to or greater than a threshold as the associated part 603 of the countermeasure-and-cause information 601.

Next, in step S10, the output unit 34 displays the associated part 603 on the display device 50. As described above, since the countermeasure-and-cause information for the input fault data is displayed together with the focus items in the first and second levels, it is possible for the user to know the cause of the selection of the countermeasure current information.

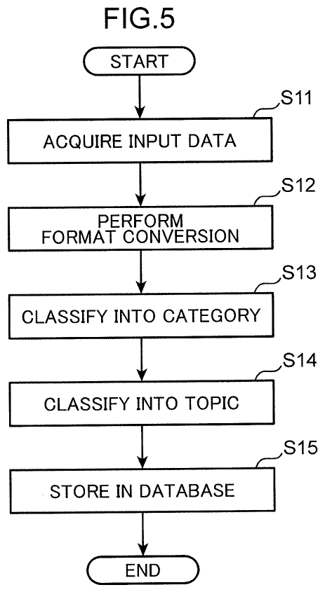

FIG. 5 is a flowchart illustrating an example of processing in which the information processing system 1 creates the database 21.

First, in step S11, the database creation unit 35 acquires input data. As the input data, the above-described past fault data is adopted. Here, since the past fault data is stored in the storage device 20, all fault data stored in the storage device 20 may be acquired as input data. Next, the database creation unit 35 converts the description format of the input data into a predetermined format.

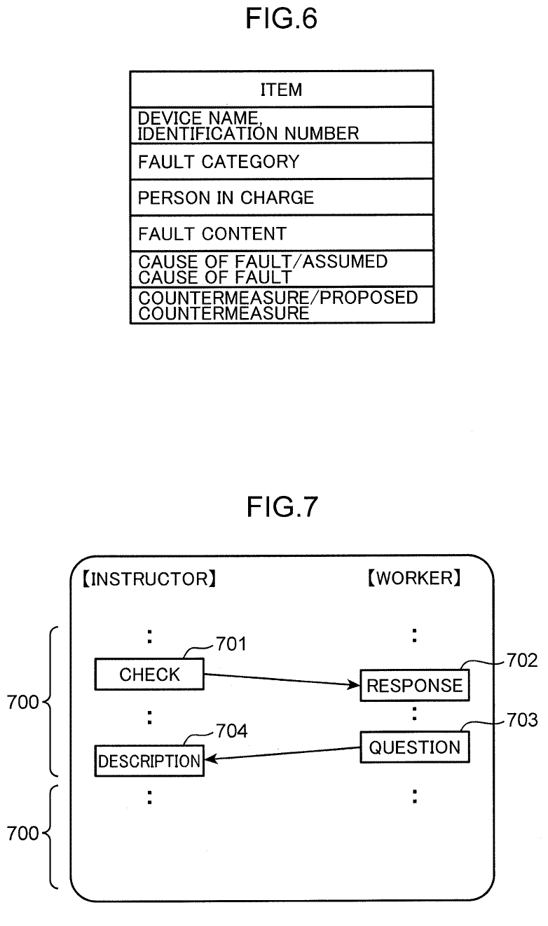

FIG. 6 is a diagram illustrating an example of a data configuration of a format. The format includes an item of “facility name, identification number”, an item of “fault category”, an item of “person in charge”, an item of “fault content”, an item of “cause of fault/assumed cause of fault”, and an item of “countermeasure/proposed countermeasure”.

In the item of “facility name, identification number”, a name and an identification number of a facility are described. In the item of “fault category”, fault categories such as “MES” and “control server” described above are described. In the item of “person in charge”, the name of the person in charge corresponding to the fault is described. The phenomenon of the fault is described in the item of “fault content”. In the item of “cause/assumed cause of fault”, a confirmed cause of fault or an assumed cause of fault that is not confirmed but is assumed is described. A plurality of causes may be described in the item of “cause of fault/assumed cause of fault”. In the item of “countermeasure/proposed countermeasure”, a correct countermeasure actually taken against the fault or a proposed countermeasure to be implemented is described.

The database creation unit 35 may extract these items by analyzing the sentence of the input data. The database creation unit 35 may perform format conversion by inputting input data to the natural language processing model and giving an instruction to classify the input data into these formats to the natural language processing model. The input data may be described according to the format illustrated in FIG. 6. In this case, the database creation unit 35 can omit the format conversion of the input data.

Next, in step S13, the database creation unit 35 classifies the input data into categories from the description of the category items of the input data.

Next, in step S14, the database creation unit 35 clusters the input data classified for each category using, for example, the k-means method or topic classification, and classifies each piece of the input data for each topic. For example, the database creation unit 35 may classify each input data into each topic by applying the topic classification to the description contents of the item “fault content” for all the input data to be processed.

Next, in step S15, the database creation unit 35 stores the countermeasure-and-cause information of the input data in the database 21 such that the category is in the first level and the topic is in the second level. As described above, the database 21 in which the countermeasure-and-cause information is hierarchically classified according to the category is generated. The database creation unit 35 may adopt the description contents of the item of “cause of fault/assumed cause of fault” and the item of “countermeasure/proposed countermeasure” as the cause-and-countermeasure information.

As described above, according to the present embodiment, the relevant focus item corresponding to the input fault data input by the user is sequentially determined from the upper level, and the relevant focus item determined for each level is presented to the user. Therefore, it is possible to present the user with a focus item for narrowing down the countermeasures to and the causes of the input fault data. Therefore, the user can learn know-how such as what to check and in what order with respect to the fault content indicated by the input fault data to narrow down the causes or countermeasures.

Modifications described below can be adopted in the present disclosure.
(1) The focus item may be determined from the conversation data indicating the conversation performed between the instructor who is a skilled worker and the worker. The sentences included in the past fault data are not necessarily in chronological order, but the conversation data records what the instructor has confirmed to the worker in chronological order. In addition, the confirmation points included in the conversation data correspond to the focus items. Therefore, the conversation data has an advantage that the focus item can be extracted in chronological order. Furthermore, in a case where a fault occurs, it is general that the instructor confirms the focus item to the worker in order from the upper level to the lower level. Therefore, the database creation unit 35 may extract the confirmation point included in the conversation data as the focus item, and determine the level of the extracted focus item based on the appearance order of the extracted focus item.

Note that the database creation unit 35 may extract the confirmation point from the conversation data by inputting the conversation data to the natural language processing model. A specific expression such as “Please check . . . ” is often used for the confirmation point. Therefore, the database creation unit 35 may extract a portion where a specific expression included in the conversation data is used as the confirmation point. As the natural language processing model, a transformer such as BERT is adopted. The conversation data input to the natural language processing model may be voice data or text data obtained by performing voice recognition on the voice data.
(2) For the fault handling, when the instructor advances the work while confirming with the worker, first, confirmation is performed with a large granularity, and if the result is correct, more detailed confirmation is performed. Then, when the confirmation is completed, the process of proceeding to the confirmation of the next larger granularity is often repeated. Therefore, the database creation unit 35 may extract the confirmation content with a large granularity from the conversation data and regard the extracted confirmation content as the focus item.

FIG. 7 is a diagram schematically illustrating the conversation data. In this schematic diagram, the left column shows the utterance content of the instructor, and the right column shows the utterance content of the worker. First, the instructor makes a confirmation utterance 701 such as “Please confirm . . . ” to the worker. In response to this, the worker makes a reply utterance 702 such as “Understood”. At this time, if the worker does not know the content of the confirmation utterance 701, the worker makes an inquiry utterance 703 to the instructor. The instructor who has received this makes an explanatory utterance 704 in response to the question.

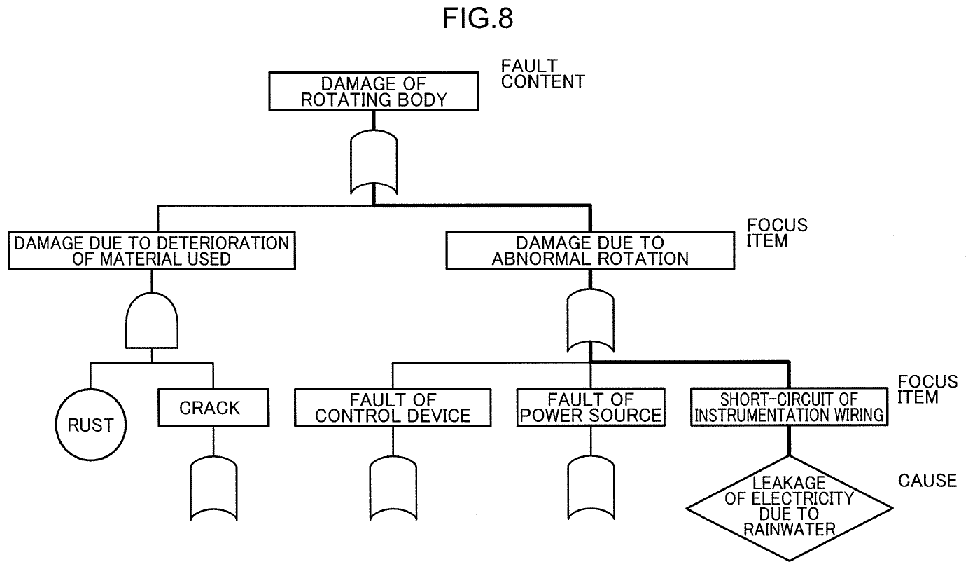

The fault handling is advanced while such a conversation is repeated between the instructor and the worker. Then, when the conversation for a certain focus point constituting the fault ends, the conversation for the next focus point in the fault is performed between the instructor and the worker. The dependence relationship of the conversation content becomes low between a conversation group 700 for a certain focus point and a conversation group 700 (not illustrated) for the next focus point. Therefore, the database creation unit 35 divides the utterance content of the worker and the utterance content of the instructor into a plurality of conversation sections using the dependence relationship between sentences. Furthermore, in one conversation group 700, the conversation content is advanced from a rough content to a detailed content. Therefore, in one conversation section, the database creation unit 35 may specify the type of the confirmation item (category) in the first level from the confirmation utterance 701 uttered first. That is, the database creation unit 35 may extract the type of the confirmation item (category) in the first level from the confirmation utterance 701 uttered first in each conversation section.
(3) The format of the past fault data may be determined in advance so as to describe the confirmation content and the handling result of the fault based on the confirmation content in chronological order. This facilitates the work of extracting the focus item from the fault data.
(4) When extracting the focus item from the sentence included in the past fault data or the conversation data, the database creation unit 35 may extract the focus item after summarizing the sentence in advance using the natural language processing model.
(5) In a case where the number of pieces of countermeasure-and-cause information finally narrowed down is enormous, it is difficult for the user to determine which countermeasure-and-cause information should be finally narrowed down. Therefore, the database creation unit 35 may determine the number of levels such that the number of pieces of countermeasure-and-cause information included in the lowest level is equal to or less than a predetermined number when extracting the focus item from the past fault data or the conversation data. In this case, the database creation unit 35 may extract the focus item by repeatedly applying the topic classification for the level lower than the second level.
(6) For the first level, the description has been given assuming that the determination unit 32 determines the focus item in the first level by inputting the input fault data to the learning model, but the present disclosure is not limited thereto. For example, the determination unit 32 may determine the focus item in the first level from the content of the category described in the input fault data. In order to complete learning of the learning model for determining the focus item in the first level, it is necessary to accumulate past fault data to some extent. Therefore, until the learning model completes the learning, the determination unit 32 may determine the focus item in the first level from the category described in the input fault data, and after the learning model completes the learning, may determine the focus item in the first level using the learning model. In this case, after the learning model completes the learning, the description of the category may be omitted from the input fault data.
(7) The database creation unit 35 creates the database from the past fault data, but the present disclosure is not limited thereto. In addition to the past fault data, the database creation unit 35 may create the database by hierarchically classifying the design data of the facility, the instruction manual, the IF-THEN rule, the video of the facility, and the operation log of the facility according to the focus item. The IF-THEN rule corresponds to a rule, “if such a fault occurs in the facility, then take such a countermeasure”. The video of the facility is a moving image obtained by photographing the operating facility. The moving image includes, for example, a moving image of the facility at the time of occurrence of the fault and a moving image of the facility in which the worker handles the fault.
(8) The determination unit 32 may determine the countermeasure-and-cause information corresponding to the input fault data based on the similarity between the input fault data and the past fault data. Also in this case, the output unit 34 may display the focus item in each level corresponding to the countermeasure-and-cause information on the display device 50. As a result, the user can learn the causal relationship between the countermeasure-and-cause information and the input fault data from the hierarchically displayed focus items. In this case, the database creation unit 35 may classify and store the past fault data in the database 21 according to the focus item. Since the past fault data includes the countermeasure-and-cause information, it is possible to specify one piece of countermeasure-and-cause information when one piece of past fault data is specified. As the similarity between the input fault data and the past fault data, for example, a cosine similarity between a vector representing a sentence included in the input fault data and a vector representing a sentence included in the past fault data can be adopted. As the vectorization of the sentence, for example, word2vector can be employed.
(9) When presenting the countermeasure-and-cause information, the output unit 34 may display fault tree analysis (FTA) related to the countermeasure-and-cause information on the display device 50. FIG. 8 is a diagram illustrating a display example of the FTA. FTA has a tree-like data configuration in which a cause is specified by sequentially tracing an upstream cause according to a tree structure starting from the fault contents. When determining the focus items in the first level and the second level and the countermeasure-and-cause information, the determination unit 32 specifies a path similar to these pieces of information from the FTA. Then, the output unit 34 may display the FTA on the display device 50 so that a path similar to these pieces of information can be recognized. This makes it possible to indicate to the user the process of narrowing down the causes.

In the example of FIG. 8, the “damage of the rotating body” is the fault content indicated by the input fault data. In this case, the determination unit 32 determines “damage due to abnormal rotation” as the focus item in the first level, and determines “short-circuit of instrumentation wiring” as the focus item in the second level. In addition, the determination unit 32 specifies “leakage of electricity due to rainwater” as the cause and result information. Therefore, the determination unit 32 specifies a path matching or similar to these determination contents from the FTA, superimposes the specific path on the FTA, and displays the same on the display device 50.
(10) The determination unit 32 may display a candidate group of the plurality of focus items on the display device 50 for each of a plurality of levels, and determine the focus item selected by the user from the candidate group as the relevant focus item for each of the plurality of levels.

For example, the determination unit 32 first displays, on the display device 50, a list of a plurality of predetermined focus items in the first level as a candidate group. In the example of FIG. 2, a list of five focus items such as “MES”, “control server”, and . . . is displayed on the display device 50 as a candidate group.

Next, the user inputs an instruction to select a focus item corresponding to the input fault data from the candidate group using the input device 40. The determination unit 32 determines the selected focus item as the relevant focus item in the first level. Here, for example, it is assumed that “MES” is selected.

Next, the determination unit 32 displays, on the display device 50, a list of a plurality of predetermined focus items in the second level as a candidate group. In the example of FIG. 2, eight topic names and topic keywords related to “MES” are displayed as a candidate group. Next, the user inputs an instruction to select a focus item corresponding to the input fault data from the candidate group using the input device 40. The determination unit 32 determines the selected focus item as the relevant focus item in the second level. Here, it is assumed that the topic “1” is selected.

Next, the determination unit 32 displays a candidate group 403 including a plurality of pieces of countermeasure-and-cause information related to the topic “1” on the display device 50. Then, the user inputs an instruction to select one piece of countermeasure-and-cause information from the candidate group 403 using the input device 40.

In this modification, the user can easily select the focus item and reflect the intention of the user in the focus item.

The present disclosure is useful in the field of training workers for facility and the like since the user can learn know-how of handling faults.

1. An information processing method in a computer, comprising:
acquiring input fault data indicating fault contents;
determining a relevant focus item corresponding to the input fault data in order from an upper level from among a plurality of focus items classified for each of a plurality of levels for narrowing down countermeasures to or causes of the fault content; and
displaying the relevant focus item determined for each of the plurality of levels on a display device.

2. The information processing method according to claim 1, wherein
the determining includes:
displaying a candidate group of a plurality of focus items on the display device for each of the plurality of levels; and
determining a focus item selected by a user from the candidate group as the relevant focus item for each of the plurality of levels.

3. The information processing method according to claim 1, wherein the determining of the relevant focus item in a first level that is an uppermost level includes determining the relevant focus item by inputting the input fault data to a learning model that has learned a relationship between fault data and the relevant focus item corresponding to the fault data.

4. The information processing method according to claim 3, wherein the determining of the relevant focus item in each level lower than the first level includes determining the relevant focus item by matching a word included in fault data with a keyword indicating a plurality of predetermined focus items.

5. The information processing method according to claim 1, further comprising extracting, based on the relevant focus item, a candidate group including a plurality of pieces of countermeasure-and-cause information that are candidates for the countermeasures to or the causes of the fault content indicated by the input fault data from a database that stores the countermeasure-and-cause information indicating the countermeasures or the causes hierarchically classified according to the plurality of focus items, and displaying the extracted candidate group on the display device.

6. The information processing method according to claim 5, further comprising:
determining one piece of countermeasure-and-cause information from the candidate group based on a selection instruction of a user;
specifying an associated part of the instruction manual related to the one piece of countermeasure-and-cause information based on instruction manual information indicating an instruction manual of a facility; and
displaying the associated part on the display device.

7. The information processing method according to claim 5, further comprising:
determining one piece of countermeasure-and-cause information from the candidate group based on a selection instruction of a user;
storing, in the database, a number of times of selection made by the user for each of a plurality of pieces of countermeasure-and-cause information from the candidate group; and
displaying the plurality of pieces of countermeasure-and-cause information included in the candidate group on the display device in descending order of the number of times of selection.

8. The information processing method according to claim 4, wherein the keyword indicating the plurality of focus items is extracted by clustering past fault data.

9. An information processing device comprising a processor,
wherein the processor is configured to execute:
acquiring input fault data indicating fault contents;
determining a relevant focus item corresponding to the input fault data in order from an upper level from among a plurality of focus items classified for each of a plurality of levels for narrowing down countermeasures to or causes of the fault content; and
displaying the relevant focus item determined for each of the plurality of levels on a display device.

10. A non-transitory computer readable medium including an information processing program for causing a computer to execute:
acquiring input fault data indicating fault contents;
determining a relevant focus item corresponding to the input fault data in order from an upper level from among a plurality of focus items classified for each of a plurality of levels for narrowing down countermeasures to or causes of the fault content; and
displaying the relevant focus item determined for each of the plurality of levels on a display device.
